(19) United States
(12) Patent Application Publication
(10) Pub. No.: US 2018/0300736 A1
(43) Pub. Date: Oct. 18, 2018

(54) MOBILE FIELD SURVEY SYSTEM AND METHOD

(71) Applicant: University of Seoul Industry Cooperation Foundation, Seoul (KR)

(72) Inventor: Jie Eun Hwang, Seoul (KR)

(73) Assignee: University of Seoul Industry Cooperation Foundation

(21) Appl. No.: 16/014,586

(22) Filed: Jun. 21, 2018

Related U.S. Application Data
(63) Continuation of application No. PCT/KR2016/015337, filed on Dec. 27, 2016.

(30) Foreign Application Priority Data
Jan. 4, 2016 (KR) 10-2016-0000344

(51) Int. Cl. G06Q 30/02; G06Q 10/06; H04W 4/02

(52) U.S. Cl. CPC G06Q 30/0201; G06Q 50/26; H04W 4/023; G06Q 10/0637

(57) ABSTRACT

Disclosed herein are a location-based mobile field survey method and apparatus. The location-based mobile field survey method includes: referring to field information stored in a field survey management system server via a field survey app installed on a terminal; entering field information, such as the address of a field, the name of a building or facilities adjacent to the field, the geographical name of the field, and/or the like, into the field survey app, and receiving a field survey method type, selected from the group consisting of point inspection, node checking, and route following, from the field survey management system server as a field survey method type for the field corresponding to the entered field information; and transmitting the result of a field survey, performed according to the field survey method type, to the field survey management system server.

### CROSS-REFERENCE TO RELATED APPLICATION

This application is a continuation of PCT/KR2016/015337 filed on Dec. 27, 2016, which claims priority to Korean Patent Application No. 10-2016-0000344 filed on Jan. 4, 2016. The applications are incorporated herein by reference.

### TECHNICAL FIELD

The present invention relates to a mobile field survey system and method, and more particularly to a mobile field survey system and method which, when performing field surveys of various urban elements, such as urban infrastructures, buildings, transportation, cultural assets, public facilities, etc, in a complex city, are capable of systematically and integrally managing information to be continuously collected over a long term and are also capable of implementing an efficient monitoring system.

### BACKGROUND ART

A city is a complex artificial ecosystem. Although various urban elements, such as urban infrastructures, buildings, transportation, cultural assets, public facilities, etc., are managed by a central or local government, the methods and tasks of the management are still based chiefly on documentation.

However, for urban development or redevelopment planning, urban regeneration planning, and urban management, it is significantly important to continuously establish and informatize monitoring administration. In order to find and solve a complex urban problem, it is necessary to set up monitoring indices suitable for a specific target, to continuously collect information over a long term, and to systematically and integrally manage the collected information.

For example, in the case of cultural assets designated as World Heritage Sites among various urban elements, persistent monitoring at a national level is required by the World Heritage Site Center. The entities of the persistent monitoring are composed of field management offices organized to perform field surveys and the relevant departments of the local government organized to collect reports from the individual fields, and the results of the persistent monitoring are finally reported to the International Cooperation Division of the Cultural Heritage Administration. The Cultural Heritage Administration performs the process of performing management based on the received reports, adjusting indices or setting up a management policy, and reporting results to the World Heritage Site Center.

Since a management area for field surveys of the above-described various urban elements distributed among remote places is wide, a survey target are is divided in most cases, and a plurality of field surveyors moves to individual sectional survey target areas and performs various survey activities. However, the above-described field surveys of the various urban elements distributed across the wide area are considerably inefficient in terms of time and cost due to various problems, such as lack of knowledge of the fields of surveyors, lack of proficiency regarding survey methods, the possibility of surveys overlapping those of other field surveyors, etc.

Furthermore, a conventional field survey and field monitoring method needs to end with the process of entering survey information and results into a management system remote from fields and making a report to a higher-rank administrator, and thus the efficiency of field survey work may be further degraded.

Therefore, there is an urgent need for the development of an analysis system which is capable of, in field survey work, providing information service adapted to encourage diverse monitoring activities, analyzing previously collected field survey information, rapidly finding a problem, issuing a warning, and taking related follow-up measures.

### SUMMARY OF THE DISCLOSURE

An object of the present invention is to provide a mobile field survey system and method which, when performing field surveys of various urban elements, such as urban infrastructures, buildings, transportation, cultural assets, public facilities, etc, in a complex city, are capable of systematically and integrally managing information to be continuously collected over a long term and are also capable of implementing an efficient monitoring system.

According to an aspect of the present invention, there is provided a location-based mobile field survey method, including: referring to field information, stored in a field survey management system server, via a field survey app installed on a terminal; entering field information, such as the address of a field, the name of a building or facilities adjacent to the field, the geographical name of the field, and/or the like, into the field survey app, and receiving a field survey method type, selected from the group consisting of point inspection, node checking, and route following, from the field survey management system server as a field survey method type for the field corresponding to the entered field information; and transmitting the result of a field survey, performed according to the field survey method type, to the field survey management system server.

The field survey management system server may be a server configured to provide field-related information and field survey information in real time.

The field survey method type may be a field survey method obtained by combining at least two of the field survey method types selected from the group consisting of point inspection, node checking, and route following.

The point inspection may be a method of surveying a designated target in detail at a single point selected from the group consisting of a building, a cultural asset, a work of art, and facilities.

The node checking may be a method of reaching a node selected from the group consisting of a landscape, a road, a manhole, an electric pole, and an air quality measurement point and designated on a path and performing a predetermined survey.

The route following may be a method of performing recording when a problem with a corresponding survey target occurs or a check point is found while moving along a path in a specific interval of the field.

According to another aspect of the present invention, there is provided a computer-readable storage medium having stored thereon a computer program which, when executed by a processor, causes the processor to execute the location-based mobile field survey method.

According to still another aspect of the present invention, there is provided a location-based mobile field survey system, including: a field information input unit configured to receive the information of a field; a control unit configured to provide a field survey method type selected from the group consisting of point inspection, node checking, and route following as a field survey method type based on the information of the field and the type of field; and an information output unit configured to receive information about the field survey method type based on the information of the field and the type of field, provided via the control unit, over a wired or wireless communication, and to output the information about the field survey method type to a screen.

The information of the field provided via the control unit may be field information selected from the group consisting of information about a map and a location adjacent to the field, information about a building and facilities adjacent to the field, and past field survey update data.

The field survey method type provided by the control unit may be a field survey method type obtained by combining at least two of the field survey method types selected from the group consisting of point inspection, node checking, and route following.

The location-based mobile field survey system may further include an information upload unit configured to enable a field surveyor to upload information about the result of a field survey to the control unit after performing the field survey according to the field survey method type.

Each of the information input unit and the information output unit may be an interface program configured to be executed by a device selected from the group consisting of a computer, a mobile phone terminal, a PDA, a notebook, an MP3 player, a tablet PC, and a sensor, or a sensor field detection unit.

The device may be a device capable of Internet connection, GPS recording, and photographing.

The control unit may be a server program configured to provide the information about the field survey method type based on the information of the field and the type of field.

The control unit may be a server program configured to provide field-related information and field survey information in real time.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic diagram showing the individual execution entities of a location-based mobile field survey system and method according to embodiments of the present invention;

FIG. 2 is a schematic diagram showing a state in which the location-based mobile field survey system according to the embodiment of the present invention has been applied to an urban management information network;

FIG. 3 is a schematic diagram showing the point inspection of the field survey method types provided by the control unit of the location-based mobile field survey system according to the embodiment of the present invention;

FIG. 4 is a schematic diagram showing the node checking of the field survey method types provided by the control unit of the location-based mobile field survey system according to the embodiment of the present invention;

FIG. 5 is a schematic diagram showing the route following of the field survey method types provided by the control unit of the location-based mobile field survey system according to the embodiment of the present invention.

FIG. 6 is a schematic diagram showing a field survey method obtained by combining at least two of the field survey method types selected from the group consisting of point inspection, node checking, and route following of the field survey method types provided by the control unit of the location-based mobile field survey system according to the embodiment of the present invention;

FIG. 7 is a schematic diagram showing the screen of the information output unit of the location-based mobile field survey system according to the embodiment of the present invention;

FIG. 8 is a schematic diagram showing the point inspection of the field survey method types which are implemented via the information output unit of the location-based mobile field survey system according to the embodiment of the present invention;

FIG. 9 is a schematic diagram showing the node checking of the field survey method types which are implemented via the information output unit of the location-based mobile field survey system according to the embodiment of the present invention; and

FIG. 10 is a schematic diagram showing the route following of the field survey method types which are implemented via the information output unit of the location-based mobile field survey system according to the embodiment of the present invention.

### DETAILED DESCRIPTION OF THE DISCLOSURE

Preferred embodiments of the present invention will be described in detail below with reference to the accompanying drawings. In the following description of the present invention, when it is determined that a detailed description of a related well-known component or function may make the gist of the present invention obscure, the detailed description will be omitted. Furthermore, in the description of the embodiments of the present invention, a specific numerical value is merely an example, and the scope of invention is not limited by the specific numerical value.

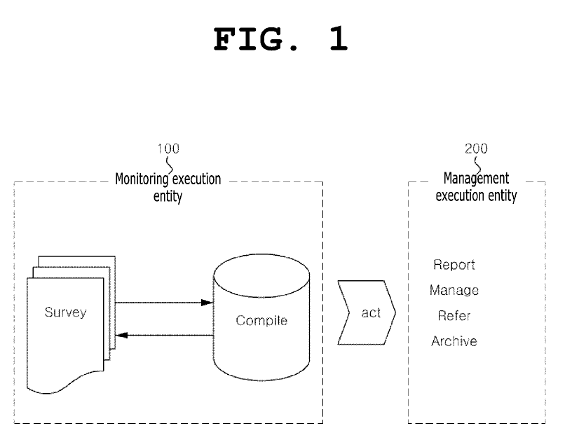

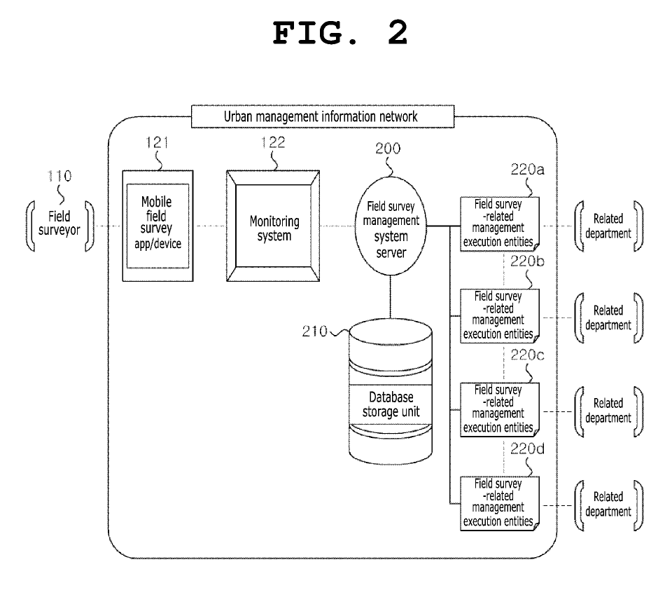

FIG. 1 is a schematic diagram showing the individual execution entities of a location-based mobile field survey system and method according to embodiments of the present invention, and FIG. 2 is a schematic diagram showing a state in which the location-based mobile field survey system according to the embodiment of the present invention has been applied to an urban management information network.

Referring to these drawings, the location-based mobile field survey method according to the present invention is configured to include: referring to field information, stored in a field survey management system server, via a field survey app installed on a terminal; entering field information, such as the address of a field, the name of a building or facilities adjacent to the field, the geographical name of the field, and/or the like, into the field survey app, and receiving a field survey method type, selected from the group consisting of point inspection, node checking, and route following, from the field survey management system server as a field survey method type for the field corresponding to the entered field information; and transmitting the result of a field survey, performed according to the field survey method type, to the field survey management system server.

In other words, the location-based mobile field survey method according to the present invention is configured such that a field surveyor 110, i.e., a monitoring execution entity 100, performs a field survey, and includes the steps of: referring to field information from a field survey management system server 200, i.e., a management execution entity; receiving a field survey method type, selected from the group consisting of point inspection, node checking, and route following, via the field survey app 121 of a terminal as a field survey method type based on the type of field, and performing a field survey according to the field survey method type; and collecting the result information of the performed field survey, and uploading the result information back to the field survey management system server 200, i.e., a management execution entity, via a field survey monitoring system 122.

Accordingly, the location-based mobile field survey method according to the present invention enables the field surveyor 110 to perform simultaneous, multiple surveys of various survey elements, improves the field awareness of the field surveyor 110 during the process of surveying various indices while moving across a predetermined interval for a predetermined period rather than intensively and exclusively surveying only a single survey element, supports determination in a field, and helps to consistently store collected information in the database storage unit 210 of the server 200, thereby enabling a survey target, such as a complex urban element or the like, to be efficiently monitored and surveyed.

Furthermore, in the location-based mobile field survey system according to the present invention, the field survey management system server 200 may be used as a server which provides field-related information and field survey information to field survey-related management execution entities 220a, 220b, 220c and 220d and an entity desiring to refer to field survey data in real time.

For example, when the location-based mobile field survey method and system according to the present invention are applied to a field survey of an urban cultural asset designated as a World Heritage Site, a field surveyor may perform a field survey by using a method of updating a field survey page of the persistent World Heritage Site monitoring system of the Cultural Heritage Administration with field survey information in real time via a mobile application, returning to a field office after the field survey, checking data entered in a field, and finally arranging the data and uploading a report. Furthermore, continuously collected information may be referred to for a management state in a field in conjunction with the management system of a local government and the cultural asset information system of the Cultural Heritage Administration, and may be integrated with a cultural asset management system to be thus shared as basic data for cultural asset management and policy making.

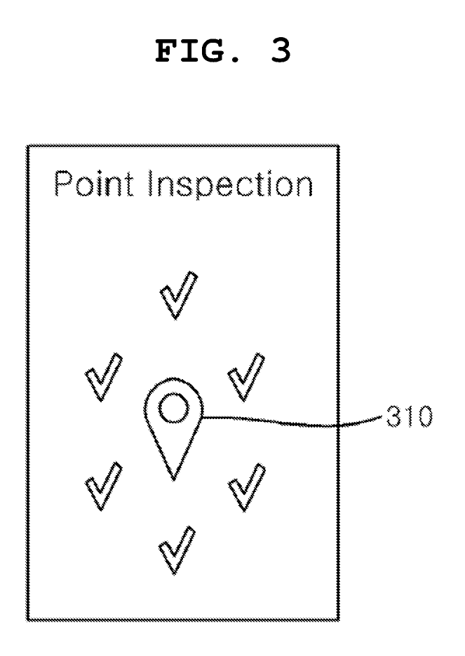

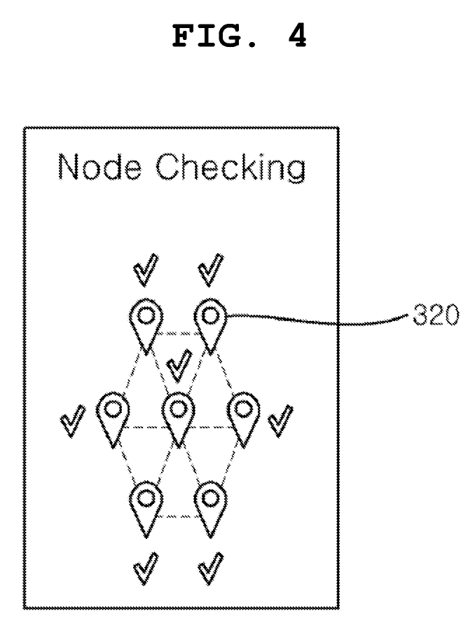

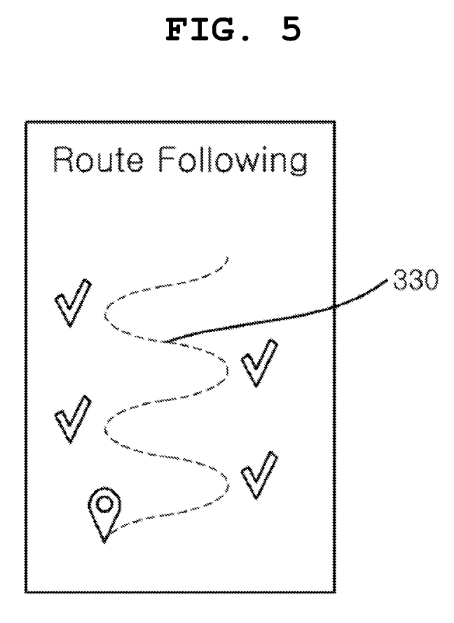

FIG. 3 is a schematic diagram showing the point inspection of the field survey method types provided by the control unit of the location-based mobile field survey system according to the embodiment of the present invention, FIG. 4 is a schematic diagram showing the node checking of the field survey method types provided by the control unit of the location-based mobile field survey system according to the embodiment of the present invention, and FIG. 5 is a schematic diagram showing the route following of the field survey method types provided by the control unit of the location-based mobile field survey system according to the embodiment of the present invention.

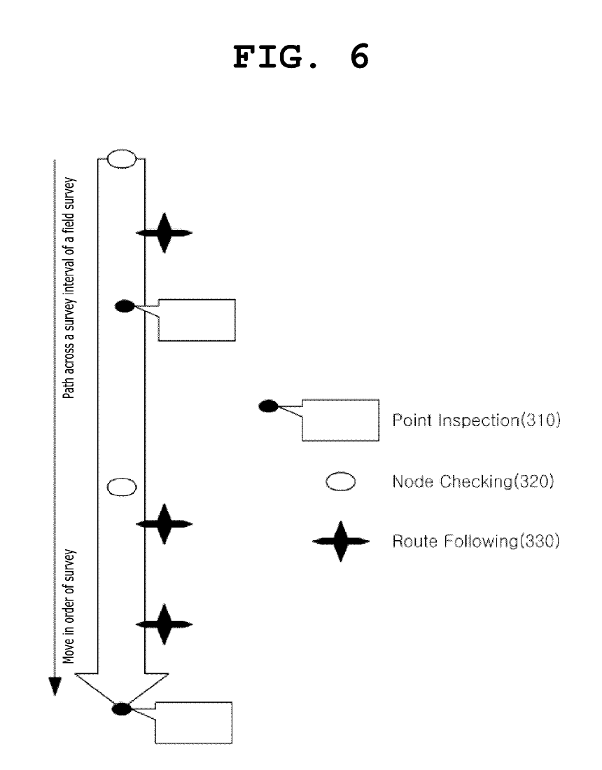

FIG. 6 is a schematic diagram showing a field survey method obtained by combining at least two of the field survey method types selected from the group consisting of point inspection, node checking, and route following of the field survey method types provided by the control unit of the location-based mobile field survey system according to the embodiment of the present invention.

Referring to these drawings, the field survey method type provided by the location-based mobile field survey method according to the present invention may be, for example, a field survey method selected from the group consisting of point inspection, node checking, and route following, preferably a field survey method obtained by combining at least two of the field survey method types selected from the group consisting of point inspection, node checking, and route following.

The point inspection field survey method is, for example, a method by which a field surveyor surveys a designated target in detail while staying at a single point 310, such as a building, a cultural asset, a work of art, or the like. The special survey indices optimized for the corresponding survey target are provided by the field survey management system server, and are provided not to overlap the indices of another survey target. Furthermore, the method's own independent inspection system, including the representative location information of the survey target, the detailed location or serial number of each member, the detailed location or serial number of each element, etc., may be provided by the field survey management system server.

The node checking field survey method is, for example, a method by which a field surveyor reaches a node 320, such as a landscape, a road, a manhole, an electric pole, an air quality measurement point, or the like, designated on a path and performs a predetermined survey. Guidance is provided by the field survey management system server such that the same index survey is repeatedly performed at each designated node. This node checking field survey method may be used for a field survey in which time and space series comparison and analysis between targets generated in the same series are important.

The route following field survey method is, for example, a method by which a field surveyor is guided by the field survey management system server to be well informed of a survey target, such as the ecology of a climbing route of the Mt. Bkhan, the rampart of Suwon Hwaseong Fortress, or the like, in a specific interval of a field and performs recording when a problem with the corresponding survey target occurs or an check point is found while moving along a route 330. The recording of a location and an index survey may be performed when the field surveyor finds a survey target while moving along the route.

Furthermore, when the range of a field which will be surveyed by a field surveyor is wide or long, the field surveyor moves in order of a survey, and makes use of a field survey method obtained by combining at least two of the field survey method types selected from the group consisting of the point inspection, node checking, and route following, thereby further improving the efficiency of field survey work.

The location-based mobile field survey method enables the field surveyor to upload information about the result of the field survey to the field survey management system server via the field survey app of a terminal after the step of performing the field survey according to the field survey method type, and thus the field survey management system server can be updated with the state information of the survey target field in real time, thereby improving the utilization of field survey information.

The location-based mobile field survey method according to the present invention may be implemented in the form of program instructions executable by a variety of computer means, and may be stored in a computer-readable storage medium. The computer-readable storage medium may include program instructions, a data file, and a data structure solely or in combination. The program instructions which are stored in the medium may be designed and constructed particularly for the present invention, or may be well known and available to those skilled in the field of computer software.

The present invention also provides a location-based mobile field survey system, including: a field information input unit configured to receive the information of a field; a control unit configured to provide a field survey method type selected from the group consisting of point inspection, node checking, and route following as a field survey method type based on the information of the field and the type of field; and an information output unit configured to receive information about the field survey method type according to the information of the field and the type of field, provided via the control unit, over a wired or wireless communication, and to output the information about the field survey method type to a screen.

Accordingly, the location-based mobile field survey system according to the present invention enables a field surveyor to perform simultaneous, multiple surveys of various survey elements, improves the field awareness of the field surveyor during a process of surveying various indices while moving across a predetermined interval for a predetermined period rather than intensively and exclusively surveying only a single survey element, supports determination in a field, and helps to consistently store collected information in the database storage unit of the server, thereby enabling a survey target, such as a complex urban element or the like, to be efficiently monitored and surveyed.

Furthermore, the location-based mobile field survey system according to the present invention is designed such that the control unit can be updated with information automatically recorded in a field during a field survey via a persistent monitoring system and data can be exchanged to enable existing monitoring data to be referred to in a field, thereby further improving the efficiency of a field survey.

The location-based mobile field survey system according to the present invention may incorporate a plan for the adjustment of task ranges between individual management entities into a process starting from a plan for information service usable in the initial work training of field surveyors. Furthermore, in a field survey, indices for survey targets configured in the form of queries are converted based on core targets, and thus an information structure (a schema) composed of individual principal observation target items and the variables of the items is defined, thereby increasing applicability to integrated analysis, automatic warning, etc.

Furthermore, the collected information of persistent monitoring is analyzed and can be utilized as a basis for further preservation and management plans, and the state of a field survey target and the meaning thereof can be utilized as educational and promotional data.

Meanwhile, the field information provided via the control unit is field information selected from the group consisting of information about a map and a location adjacent to the field, information about a building and facilities adjacent to the field, and past field survey update data, thereby improving the utilization of information by a field surveyor.

The location-based mobile field survey system may include an information upload unit configured to enable the field surveyor to upload information about the result of the field survey to the control unit after performing the field survey according to the field survey method type. The information upload unit enables the field survey management system server to be updated with the state information of the survey target field in real time, thereby improving the utilization of field survey information.

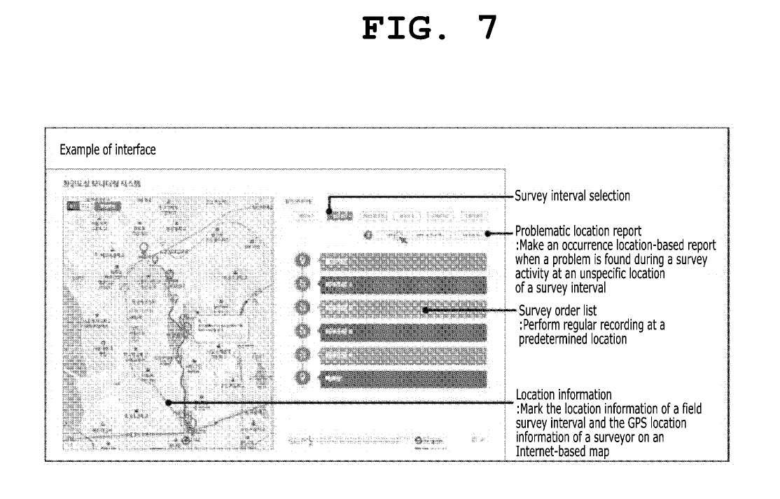

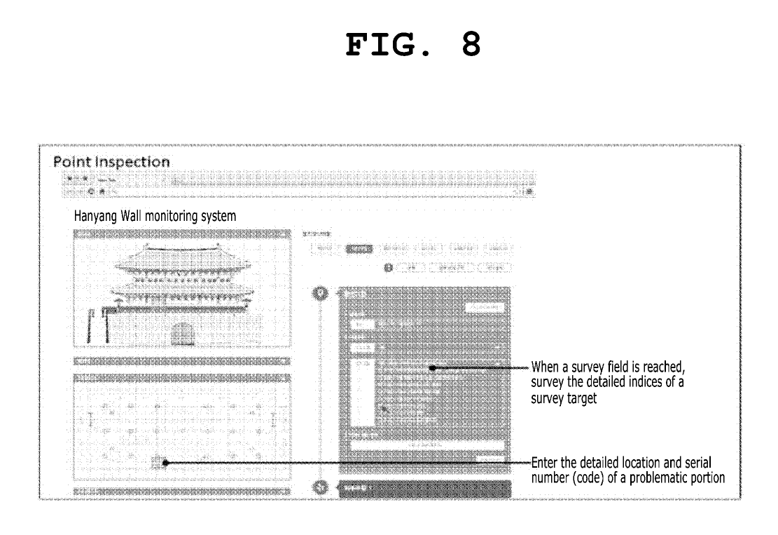

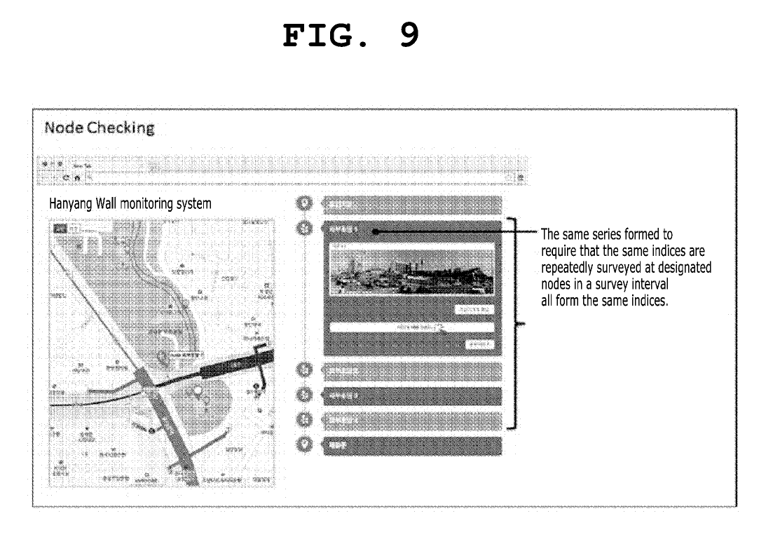

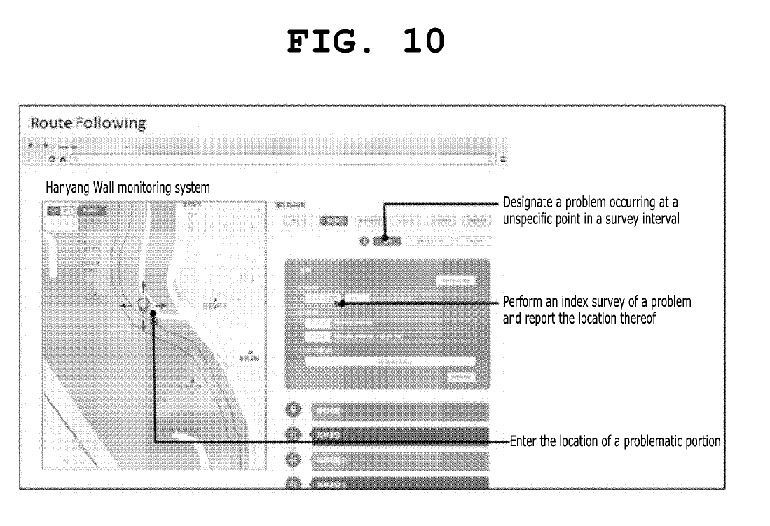

FIG. 7 is a schematic diagram showing the screen of the information output unit of the location-based mobile field survey system according to the embodiment of the present invention, FIG. 8 is a schematic diagram showing the point inspection of the field survey method types which are implemented via the information output unit of the location-based mobile field survey system according to the embodiment of the present invention, FIG. 9 is a schematic diagram showing the node checking of the field survey method types which are implemented via the information output unit of the location-based mobile field survey system according to the embodiment of the present invention, and FIG. 10 is a schematic diagram showing the route following of the field survey method types which are implemented via the information output unit of the location-based mobile field survey system according to the embodiment of the present invention.

Referring to these drawings, in the location-based mobile field survey system according to the present invention, the information output unit is an interface program configured to be executed via a device selected from the group consisting of a computer, a mobile phone terminal, a PDA, a notebook, an MP3 player, a table PC, and a sensor, or a sensor field detection unit, and may be displayed via various devices along with the information input unit.

In this case, the device is preferably a device capable of Internet connection, GPS recording, and photographing, and may be composed of a device capable of maximizing the convenience and efficiency of a field survey.

The information output unit may display a field survey method type selected from the group consisting of point inspection, node checking, and route following, or a field survey method type obtained by combining at least two of the field survey method types selected from the group consisting of point inspection, node checking, and route following as the field survey method type information provided via the control unit.

The control unit is a server program configured to provide field survey method type information based on the information of the field and the type of field, may provide field survey method type information selected from the group consisting of point inspection, node checking, and route following to the information output unit, and may provide field-related information and field survey information to field survey-related management execution entities and an entity desiring to refer to field survey data in real time.

Furthermore, the control unit may include a computer-readable storage medium implemented in the form of program instructions executable by a variety of computer means. The computer-readable storage medium may include program instructions, a data file, and a data structure solely or in combination. The program instructions which are stored in the medium may be designed and constructed particularly for the present invention, or may be well known and available to those skilled in the field of computer software. Examples of the computer-readable storage medium include magnetic media such as a hard disk, a floppy disk and a magnetic tape, optical media such as CD-ROM and a DVD, magneto-optical media such as a floptical disk, and hardware devices particularly configured to store and execute program instructions such as ROM, RAM, and flash memory.

The mobile field survey system and method according to the present invention have the advantages of, when performing field surveys of various urban elements, such as urban infrastructures, buildings, transportation, cultural assets, public facilities, etc, in a complex city, being capable of systematically and integrally managing information to be continuously collected over a long term and also being capable of implementing an efficient monitoring system.

While the present invention has been described in conjunction with specific details, such as specific components, and limited embodiments and diagrams above, these are provided merely to help an overall understanding of the present invention. The present invention is not limited to these embodiments, and various modifications and alterations may be made based on the foregoing description by those having ordinary knowledge in the art to which the present invention pertains.

Therefore, the technical spirit of the present invention should not be determined based on only the described embodiments, and the following claims, all equivalents to the claims and equivalent modifications should be construed as falling within the scope of the spirit of the present invention.

What is claimed is:

1. A location-based mobile field survey method, comprising:
referring to field information, stored in a field survey management system server, via a field survey app installed on a terminal;
entering field information, such as an address of a field, a name of a building or facilities adjacent to the field, a geographical name of the field, and/or the like, into the field survey app, and receiving a field survey method type, selected from the group consisting of point inspection, node checking, and route following, from the field survey management system server as a field survey method type for the field corresponding to the entered field information; and
transmitting a result of a field survey, performed according to the field survey method type, to the field survey management system server.

2. The location-based mobile field survey method of claim 1, wherein the field survey management system server is a server configured to provide field-related information and field survey information in real time.

3. The location-based mobile field survey method of claim 1, wherein the field survey method type is a field survey method obtained by combining at least two of field survey method types selected from the group consisting of point inspection, node checking, and route following.

4. The location-based mobile field survey method of claim 1, wherein the point inspection is a method of surveying a designated target in detail at a single point selected from the group consisting of a building, a cultural asset, a work of art, and facilities.

5. The location-based mobile field survey method of claim 1, wherein the node checking is a method of reaching a node selected from the group consisting of a landscape, a road, a manhole, an electric pole, and an air quality measurement point and designated on a path and performing a predetermined survey.

6. The location-based mobile field survey method of claim 1, wherein the route following is a method of performing recording when a problem with a corresponding survey target occurs or a check point is found while moving along a path in a specific interval of the field.

7. A computer-readable storage medium having stored thereon a computer program which, when executed by a processor, causes the processor to execute the method of claim 1.

8. A location-based mobile field survey system, comprising:
a field information input unit configured to receive information of a field;
a control unit configured to provide a field survey method type selected from the group consisting of point inspection, node checking, and route following as a field survey method type based on the information of the field and a type of field; and
an information output unit configured to:
receive information about the field survey method type based on the information of the field and the type of field, provided via the control unit, over a wired or wireless communication; and
output the information about the field survey method type to a screen.

9. The location-based mobile field survey system of claim 8, wherein the information of the field provided via the control unit is field information selected from the group consisting of information about a map and a location adjacent to the field, information about a building and facilities adjacent to the field, and past field survey update data.

10. The location-based mobile field survey system of claim 8, wherein the field survey method type provided by the control unit is a field survey method type obtained by combining at least two of field survey method types selected from the group consisting of point inspection, node checking, and route following.

11. The location-based mobile field survey system of claim 8, further comprising an information upload unit configured to enable a field surveyor to upload information about a result of a field survey to the control unit after performing the field survey according to the field survey method type.

12. The location-based mobile field survey system of claim 8, wherein each of the information input unit and the information output unit is an interface program configured to be executed by a device selected from the group consisting of a computer, a mobile phone terminal, a PDA, a notebook, an MP3 player, a tablet PC, and a sensor, or a sensor field detection unit.

13. The location-based mobile field survey system of claim 12, wherein the device is a device capable of Internet connection, GPS recording, and photographing.

14. The location-based mobile field survey system of claim 8, wherein the control unit is a server program configured to provide the information about the field survey method type based on the information of the field and the type of field.

15. The location-based mobile field survey system of claim 8, wherein the control unit is a server program configured to provide field-related information and field survey information in real t
